(19) United States
(12) Patent Application Publication
(10) Pub. No.: US 2012/0030571 A1
(43) Pub. Date: Feb. 2, 2012

(54) System and Method for Controlling Local Computer Applications Using a Web Interface

(75) Inventors: Paramjit Gill, Ottawa (CA); Chung Ming Tam, Ottawa (CA); Stefan Van Kessel, Ottawa (CA)

(73) Assignee: TOPEER CORPORATION, Ottawa (CA)

(21) Appl. No.: 13/018,507

(22) Filed: Feb. 1, 2011

Related U.S. Application Data
(63) Continuation of application No. 11/677,027, filed on Feb. 20, 2007, now abandoned.

(30) Foreign Application Priority Data
Feb. 20, 2006 (CA) 2,537,001

(51) Int. Cl. G06F 3/00; G06F 15/16

(52) U.S. Cl. 715/733

(57) ABSTRACT

A system for a user to control one or more Local Applications of a Computing Device via a Web Browser, said system comprising: the Computing Device and one or more Local Applications located thereon, wherein said Local Applications are capable of accessing resources located on said Computing Device; an Interpreter Module in communication with said one or more Local Applications; and a Web Browser in communication with said Interpreter Module and capable of interpreting and displaying information; wherein said Web Browser is used to operate said one or more Local Applications via said Interpreter Module; said Interpreter Module interpreting and relaying data packets between said Web Browser and said one or more Local Applications;

### FIELD OF THE INVENTION

This invention relates generally to the field of computer systems and implementation methods and, more specifically, to a system and method for controlling local computer applications using a Web interface.

### BACKGROUND OF THE INVENTION

In software design, the graphical user interface (GUI) is the most common method of controlling and displaying information. The development of a GUI varies according to the type of system layout being used. A local GUI system exists when the GUI and the application software program are installed on the same Computing Device. In contrast, a client-server GUI system exists when the GUI resides on a different (usually the client) Computing Device, and controls the operations of software applications on another (usually the server) Computing Device. Developing a GUI for desktop applications requires that software libraries be included in the application (for example, GTK+, Qt, Motif and the like) or that components required to create the GUI are embedded within the program language (for example, Visual Basic). In comparison, developing a GUI for a client-server system necessitates the use of a Web Browser on the client side to manage communication with the remote Computing Device. Most website designs feature, for example, scroll bars, pull-down menus, and buttons, all of which form a part of the GUI. The Web Browser communicates with a web server on the network, which interacts with a client server to perform the desired operation on the remote Computing Device.

There are disadvantages to both the local and the client-server-based GUI systems. In reference to local GUI systems, it is generally difficult to redesign or change the GUI interface, import or export the GUI to or from other language (e.g. a written language such as French or English as opposed to a programming language) or to or from another software platform (e.g. Windows, UNIX, etc.), and to enforce interface standards. When considering web applications, the client-server approach requires a web-server, which is resource intensive when compared to local GUI systems; is intended for network operations where the client and server are distinct entities; and does not allow the Web Browser to access local resources (for example, files or operating system operations).

Current attempts to solve the aforementioned issues have achieved limited success. An example of contemporary attempts to solve these issues is the use of embedded web servers, which can be limited to specific types of hardware. Another example is the development of plug-ins to enable access to local resources. Plug-ins are software applications that interact with a Web Browser to provide additional functionality. The plug-in approach, however, creates new problems related to browser compatibility.

The use of hypertext transfer protocol (HTTP) as the basis for a GUI is well established in the art. For example, U.S. Pat. No. 5,204,947 to Bernstein, et al. provides a system allowing for the creation of documents with hyperlinks to other documents managed by other software applications on the local Computing Device, similar to content in an HTML document. The system incorporates a uniform and consistent graphic user interface, such as menus and dialog boxes to allow users to navigate between linked documents.

An extension of this concept, hypertext control through a browser, can be found in U.S. Pat. No. 5,801,689 to Huntsman. Huntsman teaches a remote-access system incorporating a standard Web Browser. This process translates GUI instructions from the remote Computing Device into hypertext, sends the hypertext over a network, and then translates the hypertext instruction back into GUI instructions. In Huntsman, the GUI and the Local Application are an integral part of each other.

The use of a Web Browser as a GUI for providing services over a network is also well known in the art. For example, U.S. Pat. No. 5,701,451 to Rogers, et al. and U.S. Pat. No. 5,721,908 to Lagarde et al. both describe systems whereby data is compiled from one or more databases by a Data Interpretation System in response to a request from a Web Browser and is then formatted into html code and returned to a Web Browser through a web server.

U.S. Pat. No. 5,734,831 to Sanders describes a method of remote administration of a UNIX-based network server using standardized HTML forms that are displayed on the Web Browser. A server translates the HTML input into UNIX code and sends back any output according to pre-loaded scripts.

U.S. Pat. No. 6,950,991 to Bloomfield, et al. teaches a method of displaying application-output data within application-output windows embedded in a Web Browser window. In all of the cited examples, the application is designed for network processes and not local services. Each application requires a web server to interpret information to and from the browser.

Based on the above discussion there are a number of problems surrounding cross platform computer control. Therefore, there is a need for a new system, method and computer program product that overcomes some of the drawbacks of the above and/or of other known systems.

### SUMMARY OF THE INVENTION

An object of the present invention is to provide a system and method for controlling local computer applications using a Web Browser interface. In accordance with an aspect of the present invention, there is provided a system for operating one or more Local Applications located on a Computing Device via a Web Browser, the system comprising: a Computing Device and one or more Local Applications located thereon; an Interpreter Module in communication with said one or more Local Applications; and a Web Browser in communication with said Interpreter Module; said Interpreter Module being configured for interpreting and communicating operating instructions received from said Web Browser to said one or more. Local Applications and, interpreting and communicating responses to said operating instructions received from said one or more Local Applications to said Web Browser for display.

In accordance with another aspect of the present invention, there is provided a method of operating a Local Application of a Computing Device via a Web Browser, the method comprising the steps of: providing an Interpreter Module; using the Web Browser, communicating operating instructions to said Interpreter Module in a first format; converting said instructions at said Interpreter Module into a second format accessible to said Local Application and communicating said converted instructions thereto; operating Local Application functions based on said converted instructions and communicating response therefrom to said Interpreter Module in said second format; and converting said response into said first format at said Interpreter Module and communicating said converted response to said Web Browser for display.

In accordance with another aspect of the present invention, there is provided a computer readable memory having recorded thereon statements and instructions for execution by a computer to carry out the method as described above.

In accordance with another aspect of the present invention, there is provided a computer program product, said product comprising: a memory having computer readable code embodied therein, for execution by a Computing Device for operating one or more Local Applications of the Computing Device via a Web Browser, said code comprising: code for receiving operating instructions from a Web Browser; code for converting said instructions into a format accessible by said one or more Local Applications and for submitting said converted instructions thereto; code for receiving response to said converted instructions from said one or more Local Applications and for converting said response into a format accessible by said Web Browser; and code for communicating said converted response to said Web Browser for display.

### BRIEF DESCRIPTION OF THE FIGURES

FIG. 1A is a diagrammatic representation of a local GUI system.

FIG. 1B is a diagrammatic representation of a client-server GUI system.

FIG. 1C is a diagrammatic representation of a system for controlling local computer applications using a web interface, according to one embodiment of the present invention.

FIG. 2 is a flowchart illustrating information flow between various components of the system of FIG. 1C.

FIG. 3 is a flowchart illustrating an exemplary implementation of the system of FIG. 1C.

FIG. 4 is an exemplary web-based GUI as displayed in two different browsers, according to an embodiment of the present invention.

FIG. 5 is an exemplary web-based GUI as displayed in two different languages, according to another embodiment of the present invention.

### DETAILED DESCRIPTION OF THE INVENTION

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention is directed towards a system, method and computer program product for accessing and controlling local resources on a Computing Device using a Web Browser as the graphic user interface (GUI), in one embodiment of the present invention, the system is comprised of one or more Computing Devices, one or more Local Applications, a Web Browser and one or more Interpreter Modules. The system's one or more Computing Devices operate using any operating system, and are capable of sending and receiving data packets. The one or more Local Applications are installed on one or more of the Computing Devices.

In one embodiment, each Local Application is in communication with an Interpreter Module. In an alternative embodiment, each Local Application comprises an Interpreter Module. In either case, the Interpreter Module is configured to receive data packets configured in a first data format that is compatible with the Web Browser and translate these data packets into a second format that is compatible with the Local Application. The Interpreter Module is also configured to receive data from the Local Application, to convert it into a format that is compatible with the Web Browser, and to send the converted data packets to the Web Browser.

The Web Browser communicates with the one or more Local Applications through the Interpreter Module, which translates the data packets sent from the Web Browser into commands that would be understood by the Local Application. The Local Application executes the commands received from the Interpreter Module and returns a response to the Interpreter Module. The Interpreter Module translates the response into a communications protocol that would be understood by the Web Browser and transmits it to the Web Browser. The Web Browser receives the data packets from the Interpreter Module and displays the results accordingly.

In one embodiment of the present invention, the system further comprises an optional Template Module, which is configured to provide structure for the display of information, wherein each template stored in the Template Module provides a specific structure which is applicable to a specific action. In this manner, a user can provide instructions to the Computing Device in order to control the operation thereof, such that the format of the instructions is independent of the operating system of the Computing Device. The use of the Template Module also allows for changes to be made to the GUI without requiring alteration of the code of the Local Application.

In one embodiment, the system can be used to control Local Applications on a remote Computing Device. In this embodiment, a Computing Device of the system that has a Web Browser installed is able to exchange data packets with a Computing Device which has one or more Local Applications and one or more Interpreter Modules installed. This system could allow a user to access and control resources on his or her home Computing Device from a remote location, or could allow a user to access a multitude of Local Applications on a number of Computing Devices connected via a network, all by means of a familiar GUI, through the use of a Template Module. In this embodiment, the Template Module can be located on a remote Computing Device in communication with the other components of the system. By using this method, control and updates to the Template Module could be centralized and standardized.

Alternatively, by integrating an Interpreter Module with or into a Local Application and with the introduction of a Template Module, the system can be used to control and display any information received from a Local Application. In this fashion, a user's ability to work with any given Computing Device becomes independent of the specific operating system, language or Local Application as the browser-based GUI acts as an intermediary. In this fashion, the learning curve associated with new operating systems or software suites can be done away with as long as appropriate templates are provided in the Template Module.

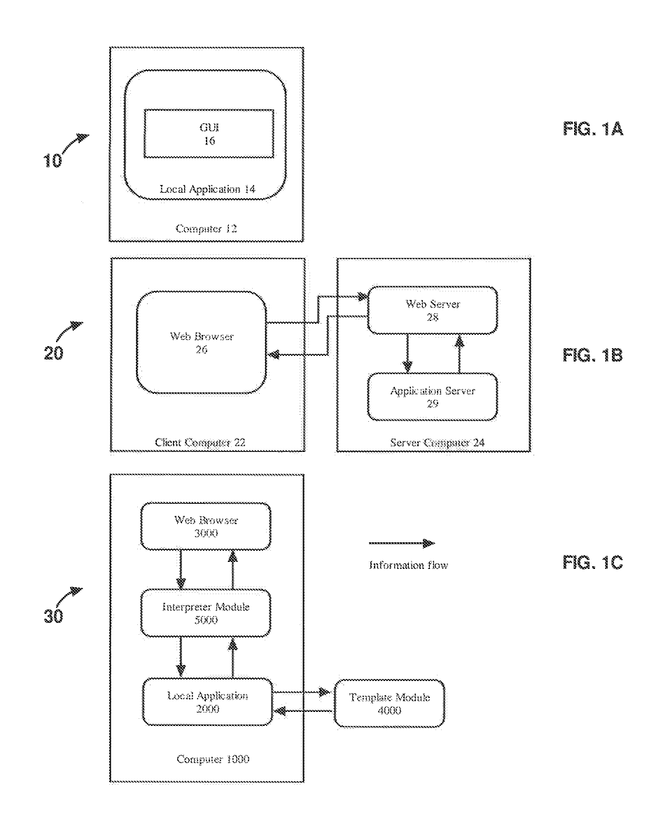

FIG. 1A depicts a local GUI system 10, as known in the art, comprising a Computing Device 12 and a Local Application 14, which contains a GUI 16. Information flow relating to the control of the Computing Device 12 occurs solely within the Local Application 14

FIG. 1S depicts a client-server GUI system 20, as known in the art, wherein information proceeds from one Computing Device 22 (commonly known as the client computer) to another Computing Device 24 (commonly known as the server computer). In this system, the GUI (not shown) for the client computer 22 is a Web Browser 26, and information is sent to and received by a web server 28 located on the server computer 24. A web server 28 exchanges information with one or more connected application servers 29 in order to process requests from the client computer 22.

With reference to FIG. 1C, and in accordance with one embodiment of the present invention, there is provided a web-based GUI system, generally referred to using the numeral 30, comprising a Computing Device 1000, a Local Application 2000, a Web Browser 3000 and a Template Module 4000. Information is exchanged directly (or indirectly via various intermediary modules) between the Web Browser 3000, the Template Module 4000, and the Local Application 2000.

In one embodiment, the Web Browser 3000 contains the GUI and communicates with the Local Application 2000. Communication between the Web Browser 3000 and the Local Application 2000 is facilitated by the Interpreter Module 5000. The Local Application 2000 also communicates with the Template Module 4000 using an appropriate communication protocol such as HTTP or file transfer protocol (FTP). It will be understood by the person skilled in the art that the Template Module 4000 can be located on the local Computing Device 1000, or located on another Computing Device accessible by the Computing Device 1000 via an appropriate communications connection.

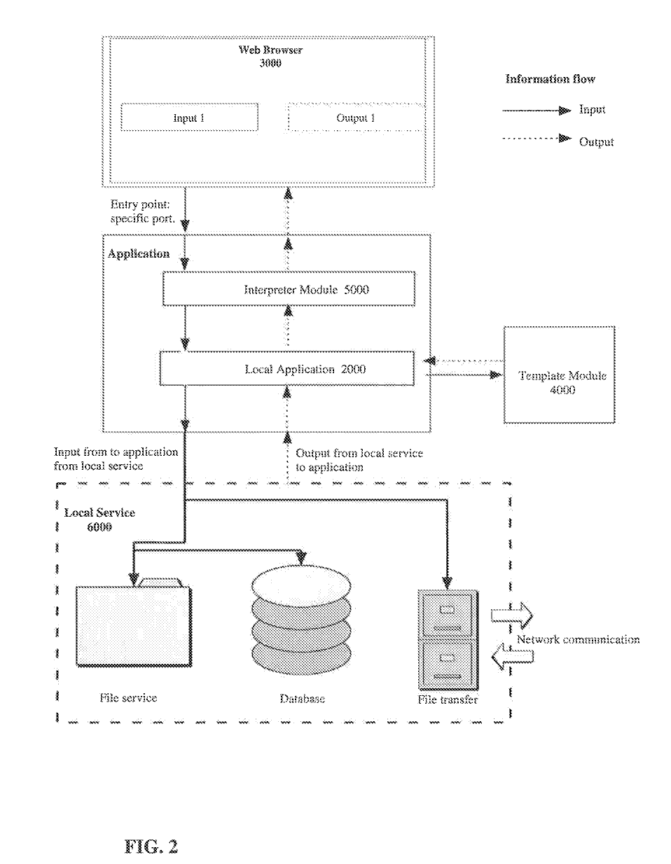

With reference to FIG. 2, there is provided a diagram of the software components of the system according to an embodiment of the present invention. FIG. 2 also maps the information flow to and from each component of the system. These components are each described in greater detail below.

### The Computing Device(s)

The system 30 generally comprises one or more Computing Devices, as in Computing Device 1000 of FIG. 1C. In the context of system 30, a Computing Device may generally comprise one or more machines that would be understood by a worker skilled in the art to include any electronic device capable of running a GUI, such as a Web Browser, an operating system, including but not limited to Windows (VISTA, XP, etc.), UNIX, or Linux, with sufficient storage and computing capability required to run a Web Browser and/or one or more Local Applications, such as Microsoft Word, Microsoft Excel, or Adobe Acrobat.

The Computing Device would also be understood to comprise one or more communication means (not shown) with which to communicate with other computing devices, or external devices where required. The communications means would be understood by a worker skilled in the art to include any necessary elements of hardware, including but not limited to communications ports, wireless transmitter/receivers, wires or fibre optics; and software that allows a computing device to exchange data packets with another computing device via such hardware elements.

In one embodiment, the computing device comprises an electronic device, such as a computer, laptop, or electronic handheld device.

With reference to FIG. 2, during operation of the system 30, the Computing Device 1000 generally comprises the computing environment within which the software components of the system 30, such as the Web Browser 3000, the Local Application 2000, and the Interpreter Module 5000, interact.

### The Web Browser(s)

The system 30 generally comprises one or more Web Browsers, as in Web Browser 3000 of FIG. 1C. In the context of system 30, a Web Browser generally comprises a software program installed on a Computing Device, that allows a user to display and interact with text, images, and other information, in standardized formats such as Hypertext Markup Language (HTML), Extensible Markup Language (XML), Cascading Style Sheets (CSS), Java and JavaScript, and the like and which can send and receive data packets using standardized communication protocols such as Hypertext Transfer Protocol (HTTP) or the like. Examples of a Web Browser may include, but are not limited to Microsoft Internet Explorer, Mozilla FireFox, and Netscape.

In one embodiment, the Web Browser acts as the GUI for the user, and communicates with the Local Application through the intermediary of the interpreter Module to fulfill requests from the user.

With reference to the embodiment of FIG. 2, during the operation of the system 30, the Web Browser's 3000 communications as part of the system 30 have two components:

Inputs: controls and/or commands are sent by the Web Browser 3000 to the Local Application 2000 via the interpreter Module 5000. For example, an authentication step for local resources stored on the Computing Device 1000 requires a password. The password is input from the Web Browser 3000 and sent to the Interpreter Module 5000, which then sends the data to the Local Application 2000.

Outputs: results and feedback are sent from the Local Application 2000 to the Web Browser 3000 via the Interpreter Module 5000. To continue the previous example, if the password is correct, the result of authentication will be sent from the Local Application 2000 to the Interpreter Module 5000, which then sends the data to the Web Browser 3000 for display to the user.

### The Local Application(s)

The system 30 generally comprises one or more Local Applications, as in Local Application 2000 of FIG. 1C. In the context of system 30, a Local Application is a software application installed on a Computing Device, such as Microsoft Word or Excel, or Adobe Acrobat or the like that has access to local resources such as operating system functions, file information, database access and file transfer. The Local Application performs specific actions with local system resources. For example, database queries or file transfers are common actions performed by the Local Application.

With reference to FIG. 2, during operation of the system, the Local Application 2000 obtains commands from the Web Browser 3000, via the interpreter Module 5000, which translates the data packets received from the Web Browser 3000 into a format understood by the Local Application 2000. The Local Application 2000 receives this data and takes action on the request by calling one or more Local Services 6000 in order to execute the commands from the Web Browser 3000. The output data is sent back to the Interpreter Module 5000.

In one embodiment, the Local Application 2000 can send output back to the Web Browser 3000 through the Interpreter Module 5000 in a format that the Web Browser 3009 would be able to interpret and display by requesting a template from the Template Module 4000 and formatting the output according to the instructions contained within the template. In another embodiment of the present invention, the Local Application 2000 is capable of venerating output in a format that the Web Browser can interpret and display, such as html, XML, javascript and the like without reference to a template.

The Local Application carries out its functions generally through the use of Local Services. A Local Service is any internal computing function that is called by the Local Application and is usually under the control of the operating system. Examples of Local Services, without limiting the generality of the foregoing would be read and write operations to disk, network communications, and file directory information. With reference to FIG. 2, during the operation of the system, the Local Application 2000 calls one or more Local Services 6000 in response to commands received from the Web Browser 3000.

### The Interpreter Module(s)

The system 30 generally comprises one or more Interpreter Modules, as in Interpreter Module 5000 of FIG. 1C. In the context of system 30, an Interpreter Module is a specialized software component that receives input data from the Web Browser, interprets the data and converts it into a format understood by the Local Application, and outputs that converted data to the Local Application. This set of data includes, at minimum, the equivalent of a “GET” and/or “POST” request. The Interpreter Module also receives input data from the Local Application in a format understood by the Local Application, and converts the data into a format understood by the Web Browser. Data from the Web Browser is sent to an entry point within the Local Application, which is defined as a port or end point for network communications.

With reference to FIG. 2, during the operation of the system, the Interpreter Module 5000 receives data packets from the Web Browser 3000 in a certain format, such as HTTP format, for example, a “POST” command. The command is converted by the Interpreter Module 5000 into a format understood by a Local Application 2000, for example, an Excel Spreadsheet “open file” command. The Interpreter Module 5000 interprets the received data from the Excel Spreadsheet format into a data format understood by the Web Browser 3000 and sends the converted data to the Web Browser 3000 for display to the user.

In one embodiment, the Interpreter Module is installed in the operating system of the Computing Device as a separate application. During operation of the system, the Web Browser sends an instruction, such as an HTTP “GET” request, the Interpreter Module receives the command, and converts it into a format understood by the Local Application, for example an SQL database query, the Local Application retrieves the required information and sends it back to the interpreter Module, which then converts the information into a format understood by a Web Browser and sends it to the Web Browser to be displayed.

In one embodiment, the Interpreter Module is provided as a component of the Local Application. In this embodiment, the Interpreter Module only needs to convert data packets received from the Web Browser into a format that can be understood by the Local Application that it is a component of.

A worker skilled in the art would appreciate that the stand-alone Interpreter Module (i.e. one that is not a component of a Local Application) would be in communication with multiple Local Applications, and would therefore need to be more complex, as it would need to translate data received from the Web Browser into a variety of data formats for different Local Applications. The Interpreter Module would need to be able to distinguish between requests directed towards different Local Applications and select the appropriate data format for each. A worker skilled in the art would appreciate the additional components that would be necessary to effect this increased functionality.

A worker skilled in the art would appreciate that the internal functions of the Interpreter Module could be accomplished in a number of ways from a software coding perspective without departing from the scope of the present invention.

### Optional Template Module

In one embodiment, the system 30 optionally comprises one or more Template Modules, as in Template Module 4000 of FIG. 1C. In the context of system 30, a Template Module is a database of stored documents or templates. The templates are generally structured documents in a format that can be interpreted by a Web Browser. Examples of technologies that can be used to create templates include: Hypertext Markup Language (HTML), Extensible Markup Language (XML), Cascading Style Sheets (CSS) and JavaScript. The purpose of the templates is to structure the output data generated by a Local Application into a form that can be easily interpreted and displayed by the Web Browser. With reference to FIG. 2, during operation of the system, the Template Module 4099 receives a request for a particular template from the Local Application 2000. In response to the request, the Template Module 4000 sends the resulting template to the Local Application 2000. The Local Application 2000 assembles the data into the proper template and outputs the resulting information to the Web Browser 3000.

In one embodiment, the Template Module is installed on the same Computing Device as the Local Application. In another embodiment of the present invention, the Template Module is located on a network which the Computing Device is connected to. During operation of the system, the Web Browser sends a request to the Local Application via the Interpreter Module, the Local Application requests through the operating system that the Computing Device connect to the required network. The Local Application retrieves the requested template from the Template Module located on the network, assembles the requested information, and sends the result to the Web Browser to be displayed. In this fashion, a single Template Module could be accessed by multiple Local Applications on multiple Computing Devices. A worker skilled in the art would appreciate that this centralization of the Template Module would enable standardized templates, allowing for more efficient updates and changes to the GUI.

In another embodiment, the Local Application retrieves the requested template from the Template Module, which could reside either locally or on a network, and sends the template to the Interpreter Module along with any data that may have been requested by the Web Browser. The interpreter Module sends the data and template to the Web Browser and the Web Browser formats the data according to the instructions contained within the template into a form that the Web Browser can display.

In one embodiment, the templates can be edited by individual users, allowing for a customizable. GUI environment. This could allow for users to download edited templates similar to the practice of downloading “skins” to customize media players or browsers.

In another embodiment, a Computing Device has both a local Template Module and can access a Template Module located on a remote Computing Device, in this embodiment, users could specify that templates stored on the local Template Module be used by default and that templates should be requested from the remote Template Module only if no corresponding template exists in the local Template Module.

In one embodiment, the Local Application has the capacity to generate output in a format that can be interpreted and displayed by a Web Browser without reference to a template.

### Use of the System

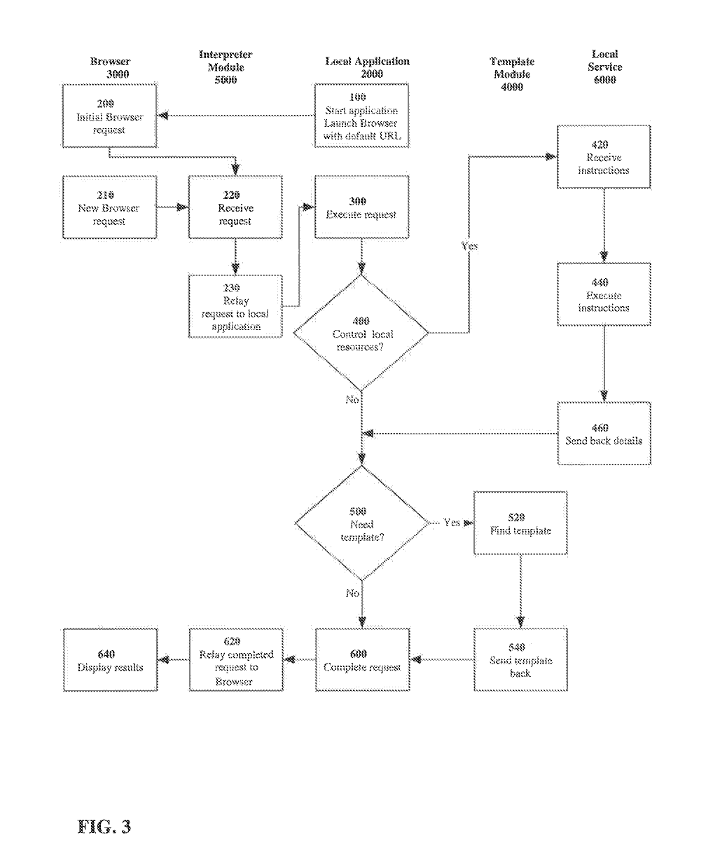

With reference to FIG. 3, there is provided a flowchart of the typical flow of information within a system for controlling local computer applications using a web interface according to an embodiment of the present invention. The following describes this system in more detail:

Step 100—Location Application: start application.

The user starts the Local Application 2000. The Local application 2000 binds to a local port on the Computing Device (not shown). The Local Application 2000 launches the Web Browser 3000.

Steps 200 and 210—Web Browser: initial request or new request

The Web Browser 3000 sends a request to the Interpreter Module 5000 that may require a display of data.

Steps 220-230—Interpreter Module: relays request.

The Interpreter Module 5000 receives the request from the Web Browser 3000, converts the request into a format compatible with the Local Application 2000 and relays the request to the Local Application 2000.

Step 300—Local Application: executes request.

The Local Application 2000 interprets the request from the Interpreter Module 5000 and executes the corresponding instructions accordingly. As part of the execution routine, in step 400, the Local Application 2000 checks whether the request includes access to local resources. If it does, the Local Application sends the necessary instructions to one or more Local Services 6000.

Steps 420-460—Local Service: receives, executes and responds to instructions.

The Local Service 6000 receives instructions from the Local Application 2000, executes the appropriate commands and then sends the results back to the Local Application 2000.

Step 500—Local Application: checks if a template is needed.

The Local Application 2000 checks the request from the Web Browser 3000 to determine whether the results require a particular template. If a template is required, a request for that template is sent from the Local Application 2000 to the Template Module 4000.

Steps 520-540—The Template Module: receives a request and sends back template.

The Template Module 4000 receives instructions regarding a request for a template. An example of a template can be a simple static HTML document; however, it can also include any type of content, which can be rendered by a Web Browser 3000. The Template Module 4000 interprets the request and then sends the appropriate template back to the Local Application 2000.

Step 600—Local Application: completes request

In one embodiment of the present invention, the Local Application 2000 can generate extensible markup language (XML) to be processed by the Web Browser 3000. The results are then sent to the Interpreter Module 5000. In another embodiment of the present invention, the Local Application 2000 will assemble the response according to the directions contained within a template requested from the Template. Module 4000. Once the response is assembled, the Local Application 2000 passes the response to the interpreter Module 5000.

Step 620—Interpreter Module: relays completed request to Web Browser.

The Interpreter Module 5000 converts the response into a format compatible with the Web Browser and transmits the converted response to the Web Browser 3000.

Step 640—Web Browser: displays results.

The Web Browser 3000 displays the information according to the instructions provided. Using client side applications such as JavaScript, the Web Browser 3000 can make further modifications to the information received from the Interpreter Module 5000. For example, the browser can display XML data generated by the Local Application 2000. In one embodiment of the present invention, the template received from the Template Module 4000 and the raw data from the Local Application 2000 are sent to the Web Browser 3000. The Web Browser 3000 then assembles the final response according to the instructions contained within the template. A worker skilled in the art would appreciate that the template would need to be sufficiently detailed to allow the Web Browser to perform this action.

This process illustrates the relationship between the various components of the system according to an embodiment of the present invention.

The invention will now be described with reference to specific examples. It will be understood that the following examples are intended to describe embodiments of the invention and are not intended to limit the invention in any way.

### EXAMPLES

The following are provided for exemplification purposes only and are not intended to limit the scope of the invention described herein in broad terms above.

### Example 1

### Using a Web Browser to Collect Information from the Local Hard Drive

The system and method disclosed herein can be applied to the use of a Web Browser to collect file information from a local hard drive on a Computing Device. It is assumed that the Local Application and the Web Browser have already been launched.

The user clicks on a link within the Web Browser: the user navigates within their Web Browser to the desired page by clicking on a hyperlink. Through XMLHttpRequest, this action sends a GET request to the Interpreter Module. The GET request contains details of the request including the version of HTTP and any local cookies. The content of a typical GET request could be as follows:

GET /Browse.html HTTP/1.1
Host: ui.2peer.com
User-Agent: Mozilla/5.0 (Windows; U; Windows NT 5.1; en-US; rv:1.8.1.1)
Gecko/20061204 Firefox/2.0.0.1
Accept:
text/xml,application/xml,application/xhtml+xml,text/html;q=0.9,text/plain;q=:0.8,i
mage/png,*/*;q=0.5
Accept-Language: en-us,en;q=0.5
Accept-Encoding: gzip,deflate
Accept-Charset: ISO-8859-1,utf-8;q=0.7,*;q=0.7
Keep-Alive: 300
Connection: keep-alive
Referer: http://ui.2peer.com/
Cookie: lang=en

The Interpreter Module receives the request and relays the instructions to the Local Application.

The Local Application acts on the instructions, which, for the purpose of this example, instruct the Local Application to obtain information regarding the files on the Computing Device by a direct query. The request will also specify that the result be displayed in a particular format. For the purposes of this example, the resulting file information should be displayed according to the description contained in the Browse.html template.

The Local Application contacts the Template Module: the Local Application sends a request, which, for the purposes of this example is sent via HTTP, to the Template Module obtain the Browse.html template. The Template Module returns the template, which is then sent to the Local Application via an HTTP response. The content of the response headers could appear as follows:

HTTP/1.1 200 OK
Date: Fri, 19 Jan 2007 16:23:27 GMT
Server: 2Peer/0.79
Cache-Control: no-cache, must-revalidate
Pragma: no-cache
Keep-Alive: timeout=15, max=93
Connection: Keep-Alive
Transfer-Encoding: chunked
Content-Type: text/html

The Local Application fills in the data according to the received template.

The Local Application sends data to the Interpreter Module.

The Interpreter Module completes the request from the Web Browser by providing the data received from the Local Application

The Browser displays the resulting information: The information from the Local Application is displayed according to the instructions of the template file.

### Example 2

### Illustration of Web Browser Independence

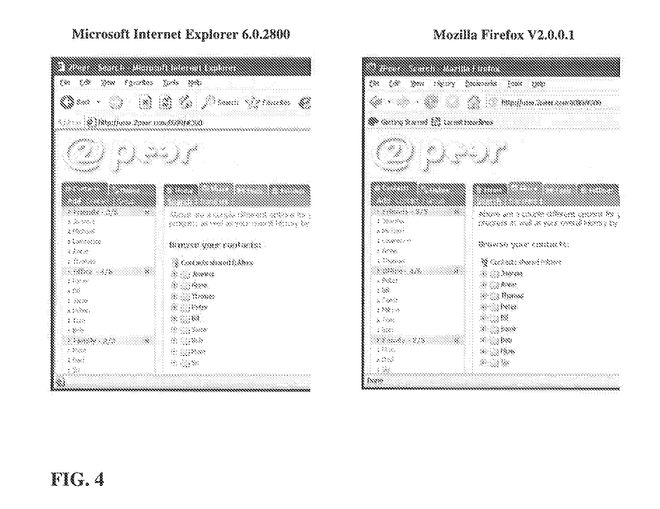

In this example, the interface control specified by the GUI design is independent of the type of Web Browser used. In general, Web Browsers are built to meet common display standards such as Hypertext Markup Language (HTML), Cascading Style Sheets (CSS) and Extensible Markup Language (XML). In addition, all Web Browsers communicate via standard communication protocols such as the IMP. By using this design process, the display properties of the GUI are independent of the Web Browser and the Local Application. As a result, different Web Browsers can control a Local Application without any change in the functionality of the Local Application. FIG. 4 is a screen capture of the GUI in two different types of Web Browsers. This example is cast in the context of Microsoft Internet Explorer 6.0.2800 versus Mozilla Firefox V2.0.0.1, however, a person skilled in the art will understand that the present invention would function with any Web Browser. Any Web Browser can be used to control the Local Application. An additional advantage provided by browser independence is the ability to tailor the templates in the Template Module for particular Web Browsers. This will ensure that the GUI will take advantage of the best set of features for each type of Web Browser.

### Example 3

### Updating GUI from a Remote Source

As discussed in greater detail above, the Template Module need not necessarily be located on the same Computing Device as the Web Browser and the Local Application. By having the Template Module reside in a remote location, the template manager is able to update the GUI associated with the Local Application on demand. The Local Application simply acts as a gateway to fetch the templates remotely using any number of communication methods. Examples of communication methods include: HTTP, HTTP over SSL (HTTPS), Remote Copy Program (RCP), Secure Copy (SCP) and File Transfer Protocol. (FTP). One advantage of this approach is that the GUI can be updated without altering the Local Application.

### Example 4

### Importing or Exporting to and from Other Platforms

Web Browsers are built on common standards: almost all web sites look and function similarly, independent of the particular Web Browser used (examples include Internet Explorer, Firefox, Safari, and Opera). These common standards allow the GUI, using a web interface, to be used without any additional development on any platform where a modern browser can be installed on different operating systems (for example Linux, Mac OS, and Windows). The Local Application can be recompiled for different platforms without changing the GUI.

### Example 5

### Changing Languages by Changing Templates

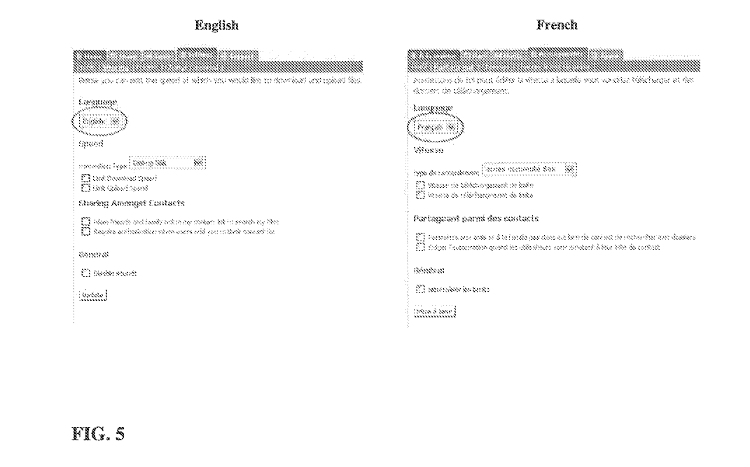

In this example, the language of the GUI can be changed from English to French in any number of ways. By using a web-based interface, different language packs can be stored remotely and a single common installer can allow for any number of supported languages. These language packs would not be retrieved until they are requested, thus reducing the size of the installer. As long as the Local Application supports an international encoding system such as Unicode, the GUI can switch languages without needing to make changes to the Local Application. FIG. 5 is an example of a GUI that can switch languages without requiring changes to the Local Application. This example is cast in the context of Firefox V. 2.0.0.1., however, a person skilled in the art will understand that another type of Web Browser could just as easily be used.

### Example 6

### Use of the System Over a P2P Network

In this example, the system is used in the context of a Peer-to-Peer (P2P) network. The system according to the present invention is used to access Local Applications and resources of Computing Devices connected to the P2P network. The system would enable transfer of files from one Computing Device connected to the network to another as well as the ability to access and work with Local Applications and data available on different Computing Devices. The standardized GUI provided by the present invention would eliminate the need to be familiar with different languages or Local Applications present on the Computing Devices connected to the network. In a sense, the present invention would allow any user of the network with access rights to treat the entire network as their local Computing Device.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

We claim:

1. A system for operating one or more Local Applications located on a Computing Device via a Web Browser, the system comprising:
a Computing Device and one or more Local. Applications located thereon;
an Interpreter Module in communication with said one or more Local Applications; and
a Web Browser in communication with said Interpreter Module;
said Interpreter Module being configured for interpreting and communicating operating instructions received from said Web Browser to said one or more Local Applications and, interpreting and communicating responses to said operating instructions received from said one or more Local Applications to said Web Browser for display.

2. The system of claim 1, the system further comprising a Template Module in communication with said one or more Local Applications, wherein said one or more Local Applications are configured to request one or more templates from said Template Module based on said operating instructions and assemble standardized documents according to said one or more templates for display by said Web Browser.

3. The system of any one of claim 1 and 2, wherein the system is distributed over two or more computing devices, said computing devices being in communication with one another.

4. The system of any one of claim 1 to 3, wherein the system comprises one or more Interpreter Modules, each of said one or more Interpreter Modules being associated with a respective one of said one or more Local Applications.

5. A method of operating a Local Application of a Computing Device via a Web Browser, the method comprising the steps of:
providing an Interpreter Module;
using the Web Browser, communicating operating instructions to said Interpreter Module in a first format;
converting said instructions at said Interpreter Module into a second format accessible to said Local Application and communicating said converted instructions thereto;
operating Local Application functions based on said converted instructions and communicating response therefrom to said Interpreter Module in said second format; and
converting said response into said first format at said interpreter Module and communicating said converted response to said Web Browser for display.

6. The method of claim 5, the providing step further comprising providing a Template Module comprising one or more templates, the method further comprising the steps of requesting one or more templates from said Template Module in response to said operating instructions and assembling standardized documents according to said one or more templates for display by said Web Browser.

7. A computer readable memory having recorded thereon statements and instructions for execution by a computer to carry out the method of any one of claim 5 and 6.

8. A computer program product, said product comprising:
a memory having computer readable code embodied therein, for execution by a Computing Device for operating one or more Local Applications of the Computing Device via a Web Browser, said code comprising:
code for receiving operating instructions from a Web Browser;
code for converting said instructions into a format accessible by said one or more Local Applications and for submitting said converted instructions thereto;
code for receiving response to said converted instructions from said one or more Local Applications and for converting said response into a format accessible by said Web Browser; and
code for communicating said converted response to said Web Browser for display.

9. The computer program product of claim 8, said code further comprising:
code for structuring said response according to one or more templates; and
code for communicating said structured response to said Web Browser for display.
